(19) United States
(12) Patent Application Publication
(10) Pub. No.: US 2026/0362380 A1
(43) Pub. Date: Nov. 12, 2026

(54) SYSTEMS AND METHODS FOR EMBEDDING CUSTOMIZED SIGNALS INTO BROADCAST STREAMS

(71) Applicant: AURA Network Systems, Inc., McLean, VA (US)

(72) Inventor: Tamara Lynne CASEY, Annapolis, MD (US)

(21) Appl. No.: 19/656,290

(22) Filed: Apr. 23, 2026

Related U.S. Application Data
(60) Provisional application No. 63/803,312, filed on May 9, 2025.

(51) Int. Cl. H04W 64/00

(52) U.S. Cl. CPC H04W 64/00

(57) ABSTRACT

Some examples of the disclosure are directed to implementing a deterministic radar system by interleaving customized waveforms into broadcasts managed by conventional broadcasting circuitry. Some examples of the disclosure are directed to transmitting and multilaterating customized waveforms using a plurality of subchannels to provide a deterministic signal for radar detection of objects moving through an airspace.

### CROSS-REFERENCE TO RELATED APPLICATIONS

This application claims the benefit of U.S. Provisional Application No. 63/803,312, filed May. 9, 2025, the content of which is herein incorporated by reference in its entirety for all purposes.

### FIELD

The present disclosure generally relates to digital signal processing and wireless communication systems. More particularly, the disclosure concerns systems and methods for combining active radar functions and traditional media delivery.

### BACKGROUND

Radar systems, particularly those used for airspace monitoring, typically require dedicated infrastructure and exclusive access to electromagnetic spectrum. The costs of deploying and maintaining such systems can be considerable. On the other hand, DTV transmission towers are widely distributed, are highly regulated, and typically operate with significant transmission power using standardized protocols such as the Advanced Television Systems Committee 3.0 (ATSC 3.0) standard. In current implementations, broadcast infrastructure is not configured to support radar functionality. Existing approaches to passive radar may opportunistically receive reflections of ambient broadcast signals, but such systems are inherently limited in precision and deterministic control. There exists, therefore, a need for systems that may potentially repurpose existing broadcast infrastructure to actively emit radar-suitable waveforms, enabling a more predictable and functional sensing modality without compromising media broadcasting capabilities. Furthermore, radar systems in current practice generally rely on spatial separation using multiple antennas or time-synchronization to achieve multilateration and geolocation.

### SUMMARY

The present disclosure contemplates leveraging a broadcast network that includes with one or more transmitters to detect objects moving in an airspace. In some examples, a common controller can communicate with one or more broadcast towers, transmitting customized waveforms to the one or more broadcast towers. In one or more examples, a custom deterministic waveform is inserted into a broadcast network transmission signal that is broadcast as part of the operation of the broadcast network. In some examples, the deterministic waveform is transmitted from a common controller to each transmitter of the broadcast network, wherein the deterministic waveform is inserted and/or interleaved with conventional broadcast signals to transmit active radar signals. In some examples, the insertion of the custom waveform allows for the utilization of the broadcast network as a radar network while complying with traditional television broadcasting standards. In some examples, the custom waveforms may be inserted by interleaving coded sequences such as radar pulses within selected OFDM subcarriers across a DTV channel. In some examples, these waveforms may be encoded using techniques such as spread-spectrum coding (e.g., CDMA-like sequences) and scheduled in deterministic time patterns (e.g., repeating bursts). In some examples, the custom waveforms are short signals that precede a longer transmitted signal that carries a form of data associated with the broadcast network. In some examples, the custom waveform provides a universal entry point into a broadcast waveform by employing a fixed configuration (e.g., sampling rate, signal bandwidth, subcarrier spacing, time domain structure) that is known to all receiver devices in the radar network. In some examples, the waveform carries information to enable processing and decoding the waveform for using in position, navigation, and timing estimation applications. When transmitted on three or more distinct subchannels, such sequences may enable a novel form of frequency-domain multilateration by providing frequency diversity at each of the transmitters of the broadcast network. In some examples, the transmitted customized waveforms may impinge upon an object traveling through an airspace, and a controller or processor in communication with receivers that detect reflections of the customized waveforms off the object may locate and/or track the aircraft. In this way, the present disclosure contemplates using customized waveforms to create a deterministic or pseudo-deterministic radar system using currently existing broadcast infrastructure.

### BRIEF DESCRIPTION OF THE FIGURES

The invention will now be described, by way of example only, with reference to the accompanying drawings, in which:

FIG. 1 illustrates an exemplary broadcast network configured for use as a radar network according to one or more examples of the disclosure.

FIG. 2 illustrates an exemplary operation of the broadcast network configured for use as a radar network according to one or more examples of the disclosure.

FIG. 3 illustrates an exemplary process for operating the broadcast network configured for use as a radar network according one or more example of the disclosure.

FIG. 4 illustrates an exemplary computing system according to one or more examples of the disclosure.

### DETAILED DESCRIPTON

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, solid state drives (SSDs), optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

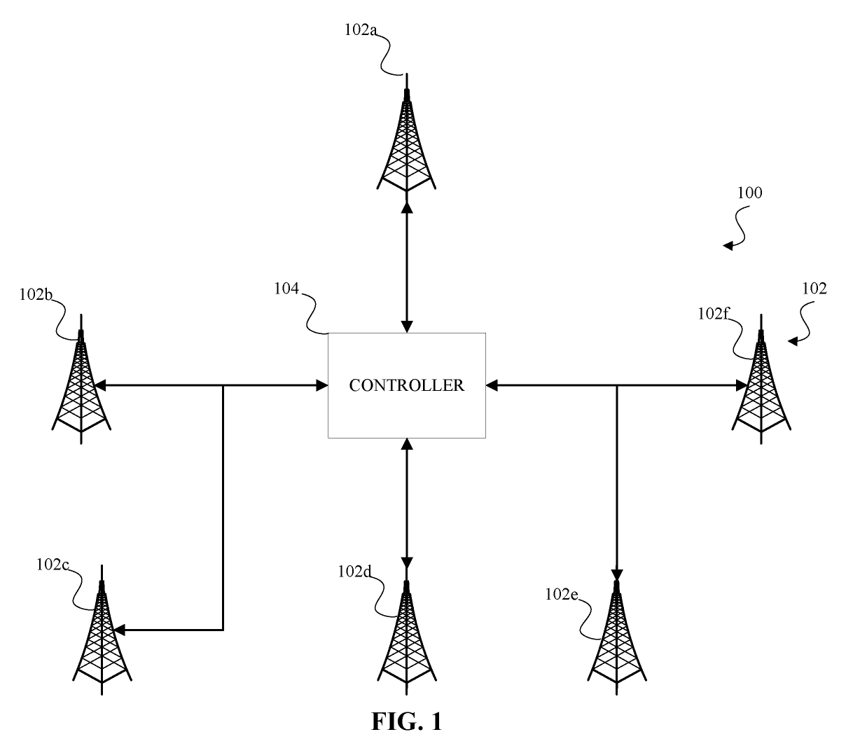

FIG. 1 illustrates an exemplary broadcast network configured for use as a radar network according to one or more examples of the disclosure. In FIG. 1, broadcast network 100 includes a controller 104, at times referred to herein as a common controller. In some examples, controller 104 is in communication with one or more transmitters, such as one or more transmitters corresponding to tower 102a, tower 102b, tower 102c, tower 102d, tower 102e, and/or tower 102f (collectively referred to as towers 102a-102f). In some examples, towers 102a-102f correspond to one or more broadcasting towers, such as television broadcast towers.

In some examples, towers 102a-102f are configured to broadcast media content and/or the custom waveforms described further herein. In some examples, controller 104 generates and/or transmits a custom waveform to towers 102a-102f. In some examples, controller 104 transmits and/or negotiates one or more subchannels which towers 102a-102f may use to transmit the custom waveform. In this way, controller 104 may indicate which subchannels may be used to transmit custom waveforms, which may be coded in accordance with instructions from controller 104 and/or based on a scheme that is agreed upon across broadcast network 100 prior to initiating the transmitting of the custom waveform.

In some examples, a signal generation subsystem may be used to produce the custom-coded waveforms at towers 102a-f. These may take the form of pseudo-random binary sequences or well-known radar coding structures such as Barker codes, Gold codes, or maximal length sequences (m-sequences). The waveform design may be driven by requirements for autocorrelation sharpness, spectral efficiency, and/or resilience to multipath fading or noise. These generated sequences may then be added into the DTV broadcast stream through integration with the processing chain of a transmission system included in a media broadcast tower, such as towers 102a-102f. This integration may occur within the multiplexer that assembles various content streams into the composite signal, or may involve dedicated insertion at the physical layer encoding stage.

The coding sequences applied in this system may employ characteristics of Direct Sequence Spread Spectrum (DSSS) or Frequency Hopping Spread Spectrum (FHSS). For example, a DSSS implementation may encode data across a wide bandwidth using orthogonal codes, allowing the receiver to correlate with a specific pattern. This may improve detection probability under low signal-to-noise ratio (SNR) conditions and allow for concurrent use of the spectrum by multiple applications. In some examples, the waveform repetition pattern may be configured in a burst format. For example, the pattern may include a 30-millisecond transmission interval followed by a 30 millisecond pause, resulting in a pulsed emission style consistent with DTV timing requirements, to enable waveform integration to boost SNR. Other timing patterns may be possible, depending on regulatory and operational constraints. Therefore, subchannels may be configured to facilitate transmission of customized coded data streams that are configured to be used as active radar signals to detect airborne entities.

In some examples, the radar signals corresponding to the custom waveforms may be transmitted using a plurality of subchannels designated for datacasting or other secondary services, preserving the integrity of spectrum allocated for primary video and audio content. In some examples, the coding sequences may be embedded into and/or mapped onto a broadcast OFDM signal, may be spread across multiple OFDM subcarriers and/or may leverage unused or available spectrum specified by a broadcast standard. For example, three discrete subchannels may be used to transmit the custom waveform, thereby enabling multilateration by using the time difference of arrival of signals sent from one or more base stations and received at a plurality of receivers. Additionally or alternatively, the customized waveform may be inserted into a data stream sent to a broadcaster to enable time-modulation of the customized waveform (e.g., of a same frequency). In some examples, the frequency diversity afforded by using a plurality of channels. In some examples, using a plurality of channels may improve the ability of controller 104 to determine a location of an object traversing an airspace. For example, the frequency diversity may reduce the effect of destructive interference (e.g., multipath fading) that may exist when transmitting and/or receiving via a single subchannel. Additionally or alternatively, using a plurality of subchannel effectively increases the bandwidth that is used to detect the object, thus reducing the impact of fading and/or noise by leveraging an aggregate of reflected signals from a plurality of subchannels, instead of relying upon results from a single subchannel.

In some examples, the received signals may be cross-referenced to generate information indicative of the location and/or track of an object moving through an airspace by controller 104. In such a configuration, a single DTV tower may be capable of transmitting signals that may impinge upon an aircraft. In response to receiving reflections of the signals impinging upon the aircraft, a plurality of receivers can communicate information to a common controller corresponding to controller 104, that is in communication with the one or more receivers. In some examples, controller 104 may use the received signals to locate and/or track the aircraft by analyzing time-differences among the received signals. For example, towers 102a-102f may individually transmit the custom waveform mapped onto a plurality of subchannels. In some examples, the custom waveforms impinge upon the aircraft and may be reflected back toward the plurality of receivers. Due to the Doppler effect, the frequency of the reflected signals may be shifted. In some examples, the plurality of receivers may transmit the received signals (i.e., the reflected signals) and/or information corresponding to the received signals to controller 104. In some examples, controller 104 may analyze the phase shifts of the signals including the custom waveforms between the plurality of receivers to determine location of the aircraft, and/or supplement the determining of the location of the aircraft.

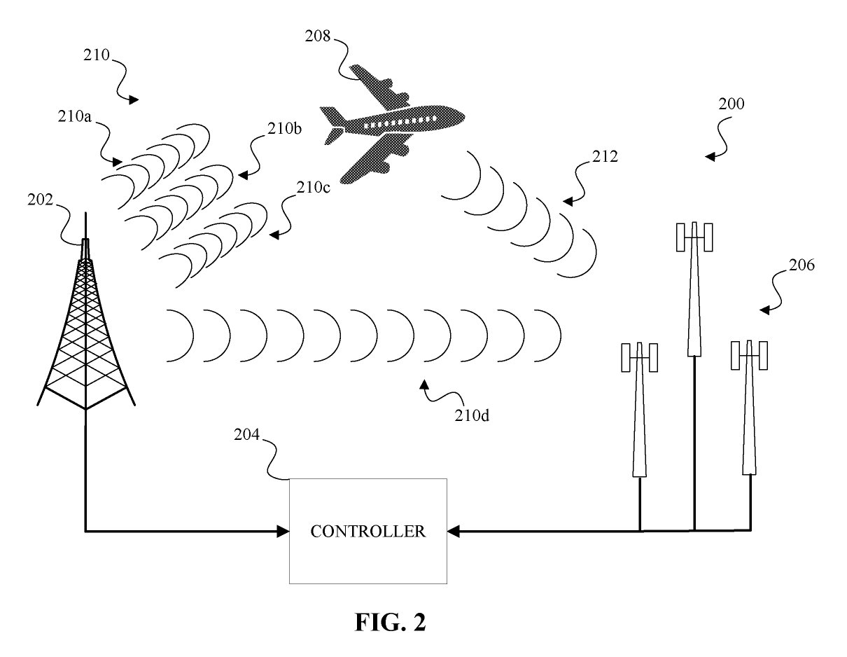

In some examples, the waveform generation and insertion logic may be stored at dedicated hardware modules co-located at a broadcast tower (e.g., towers 102a-102f). In some examples, the waveform generation and insertion logic may be deployed remotely and connected via internet protocol (IP) transport to the broadcast tower. In some examples, a third-party provider may generate the radar waveforms and transmit the waveforms to a broadcaster via a secure datastream, such as to controller 104. In some examples, the broadcast tower 102a-102f may be responsible for scheduling and mapping the sequences to the correct subchannels. In this way, the proposed systems can support frequency diverse spatial multilateration and multiplexing of radar waveforms within the OFDM transmission that enables a capability that extends beyond functionality expressly enumerated in the broadcast standard. Multilateration, as described further herein, may refer to using a time difference in arrival (TDOA) of a plurality of signals received by a plurality of receivers including receivers 206 in communication with controller 204 to determine the position of an airborne object, as described with reference to FIG. 2. In some examples, the plurality of receivers are spatially separated. In some examples, the plurality of receivers transmit information to controller 104 indicating respective TDOAs of the plurality of signals. In some examples, controller 104 uses the differences in TDOA to multiliterate the location of an airborne object.

In some examples, towers 102a-102f may interleave the custom waveform with the media broadcast signals. In some examples, towers 102a-102f are configured to broadcast using a channel indicated by a broadcast standard, such as ATSC 3.0. For example, towers 102a-102f are configured to broadcast on a 6MHz channel and/or using an orthogonal frequency-division multiplexing (OFDM) modulation scheme, according to the ATSC 3.0 standard. In some examples, broadcast network 100 includes one or more of towers 102a-102f that are configured to use a plurality of subchannels indicated by the controller 104 to transmit the custom waveform using a same transmission path to transmit the custom waveforms and to transmit the media broadcast.

Because the custom waveform is known to controller 104, controller 104 is able to decode reflections of the custom waveform transmitted using the plurality of subchannels. Moreover, the custom waveform may allow broadcast network 100 to operate as an active radar network, optionally in view of constraints on the waveform required to comply with the relevant broadcast standard.

FIG. 2 illustrates an exemplary operation of the broadcast network configured for use as a radar network according to one or more examples of the disclosure. System 200 illustrates a controller 204 (e.g., corresponding to controller 104) communicating with a tower 202 (e.g., corresponding to towers 102a-102f) to transmit custom waveforms 210 over a plurality of subchannels that impinge upon aircraft 208, and are detected by receivers 206. It is understood that aircraft 208 may correspond to different types of objects and/or different numbers of objects (e.g., one or more objects) in an airspace of system 200. It is also understood that receivers 206 may correspond to different types of receivers distributed throughout the environment of system 200.

As described above, controller 204 may generate a custom waveform that is transmitted to tower 202. After receiving the custom waveform, tower 202 may generate one or more subchannels for transmitting the custom waveform (e.g., in view of any broadcasting or other standards, as described above) concurrent with and/or temporally interleaved with media programming. Waveforms 210a, for example, may correspond to a first subchannel. Waveforms 210b, for example, may correspond to a second subchannel. Waveforms 210c, for example, may correspond to a third subchannel. Each of the first, second, and third subchannels may be different from each other.

Receivers 206 may receive a plurality of signals, including a reference signal 210d transmitted by tower 202. In some examples, receivers 206 receive one or more reflections of waveforms 210a-210c, which may be represented by reflected signals 212. In some examples, receivers 206 (and/or additional or alternative receivers) may transmit to controller 204, the received signals corresponding to reflected signals 212 and/or additional or alternative information corresponding to reflected signals 212. Controller 204, in response to receiving such information, may determine the location of aircraft 208 based on the received signals from receivers 206 (and/or the additional or alternative receivers) as described above.

In some examples, controller 204 receives information from one or more broadcast operational support systems. For example, one or more television broadcast networks optionally transmit information indicating that a status of one or more transmitters within the broadcast network have changed. In some examples, the change in status includes one or more transmitters being offline or online. Additionally or alternatively, the change in status includes adverse conditions that detrimentally affect the capabilities of a transmitter, or favorable conditions indicating that the transmitter is operating within a nominal range of operation. In some examples, the one or more broadcast operational support system includes the circuitry and/or logic used to combine the data stream corresponding to the custom waveforms described herein with other data streams (e.g., for TV broadcast, control of the broadcast, and/or the like).

In some examples, the controller 204 updates the transmitting and/or receiving of the customized waveforms and/or the determining of a location based on reflections based on the received information. For example, controller 204 changes one or more characteristics of receivers 206 based on the information from the one or more broadcast operational support systems, such as a beam index, integration time, gain control, filtering, and/or coding rate based on the information. Additionally or alternatively, controller 204 may determine one or more subchannels which are used to transmit the customized waveforms are preferred and indicate to the broadcaster (e.g., transmitting tower 202) the preferred subchannels. For example, controller 204 may generate a prediction using the information from the broadcast operational support system indicating that certain subchannels will be preferred, based on a signal-to-interference ratio for the preferred subchannels being higher than other subchannels. In response to receiving the prediction and/or an indication of the preferred subchannels, the broadcaster may transmit the customized waveform mapped on to the preferred subchannels.

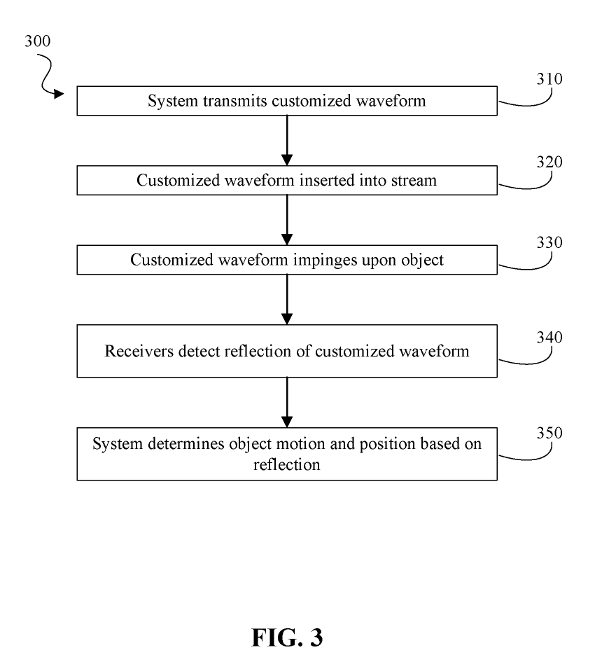

FIG. 3 illustrates an exemplary process for operating the broadcast network configured for use as a radar network according one or more example of the disclosure. In particular, process 300 may include a plurality of steps, which may include a system transmitting a customized waveform (step 310). For example, controller 104 described above may transmit the custom waveform to one or more towers, as described with reference to FIG. 1. Process 300 may include embedding the custom waveform into a broadcast stream (step 320). For example, towers 102a-102f may insert the custom waveform into the broadcast stream, as described with reference to FIG. 1. In some embodiments, process 300 includes the custom waveform and/or signals corresponding to the custom waveform impinging upon an airborne object (at step 330), such as custom waveforms 210 as described with reference to FIG. 2. In some embodiments, process 300 includes receivers detecting reflections of the custom waveform (at step 340), such as reflected signals 212 described with reference to FIG. 2. In some embodiments, process 300 includes determining the motion and/or position of the object based on the reflections (at step 350), such as described with reference to controller 104 in FIG. 1.

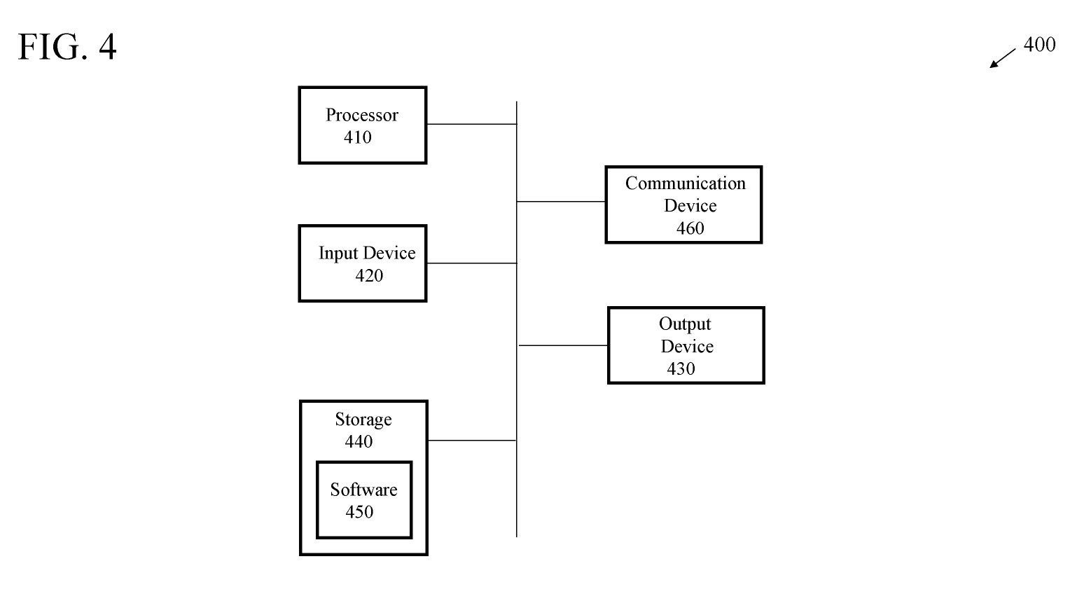

FIG. 4 illustrates an example of a computing system 400, in accordance with some examples System 400 can be a client or a server. As shown in FIG. 5, system 400 can be any suitable type of processor-based system, such as a personal computer, workstation, server, handheld computing device (portable electronic device) such as a phone or tablet, or dedicated device. The system 400 can include, for example, one or more of input device 420, output device 430, one or more processors 410, storage 440, and communication device 460. Input device 420 and output device 430 can generally correspond to those described above and can either be connectable or integrated with the computer.

Input device 420 can be any suitable device that provides input, such as a touch screen, keyboard or keypad, mouse, gesture recognition component of a virtual/augmented reality system, or voice-recognition device. Output device 430 can be or include any suitable device that provides output, such as a display, touch screen, haptics device, virtual/augmented reality display, or speaker.

Storage 440 can be any suitable device that provides storage, such as an electrical, magnetic, or optical memory including a RAM, cache, hard drive, solid state drive, removable storage disk, or other non-transitory computer readable medium. Communication device 460 can include any suitable device capable of transmitting and receiving signals over a network, such as a network interface chip or device. The components of the computing system 400 can be connected in any suitable manner, such as via a physical bus or wirelessly.

Processor(s) 410 can be any suitable processor or combination of processors, including any of, or any combination of, a central processing unit (CPU), field programmable gate array (FPGA), and application-specific integrated circuit (ASIC). Software 450, which can be stored in storage 440 and executed by one or more processors 410, can include, for example, the programming that embodies the functionality or portions of the functionality of the present disclosure (e.g., as embodied in the devices as described above)

Software 450 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 440, that can contain or store programming for use by or in connection with an instruction execution system, apparatus, or device.

Software 450 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 400 can implement any operating system suitable for operating on the network. Software 450 can be written in any suitable programming language, such as C, C++, Java, or Python. In various examples, application software embodying the functionality of the present disclosure can be deployed in different configurations, such as in a client/server arrangement or through a Web browser as a Web-based application or Web service, for example.

Therefore, according to one or more examples of the disclosure are drawn to a method which can comprise transmitting, from a controller, a custom waveform to transmitting circuitry configured to embed the custom waveform into one or more broadcast signals on three or more subchannels, receiving, at the controller and from a plurality of receivers, information corresponding to a plurality of reflections generated by the custom waveform impinging upon an object traveling through an airspace, and determining, at the controller, a position of the object, wherein the determining includes using multilateration based on the information received from the plurality of receivers. Optionally, the one or more broadcast signals correspond to digital television (DTV) signals. Optionally, the transmitting circuitry is included at a DTV broadcast tower. Optionally, the three or more subchannels are included in a 6MHz channel associated with the one or more broadcast signals. Optionally, the method can further comprise receiving information from one or more operational broadcast systems, and in response to receiving the information, adjusting the determining of the position of the object based on the information.

Some examples of the disclosure are drawn to a system for detecting and tracking one or more airborne objects, which can comprise one or more bistatic or multi-static receivers, a memory, one or more processors, wherein each processor of the one or more processors is communicatively coupled to each bistatic or multi-static receiver of one or more bistatic or multi-static receivers, wherein the memory stores one or more programs that when executed by the one or more processors, cause the one or more processors to perform one or more operations comprising, transmitting, from a controller, a custom waveform to transmitting circuitry configured to embed the custom waveform into one or more broadcast signals on three or more subchannels; receiving, at the controller and from a plurality of receivers, information corresponding to a plurality of reflections generated by the custom waveform impinging upon an object traveling through an airspace, and determining, at the controller, a position of the object, wherein the determining includes using multilateration based on the information received from the plurality of receivers. Optionally, the one or more broadcast signals correspond to digital television (DTV) signals. Optionally, he transmitting circuitry is included at a DTV broadcast tower. Optionally, the three or more subchannels are included in a 6MHz channel associated with the one or more broadcast signals. Optionally, the one or more operations further comprise, receiving information from one or more operational broadcast systems, and in response to receiving the information, adjusting the determining of the position of the object based on the information.

Some examples of the disclosure are drawn to a non-transitory computer readable storage medium storing one or more programs for detecting and tracking one or more airborne objects, for execution by one or more processors of an electronic device that when executed by the electronic device, cause the electronic device to perform one or more operations comprising, transmitting, from a controller, a custom waveform to transmitting circuitry configured to embed the custom waveform into one or more broadcast signals on three or more subchannels; receiving, at the controller and from a plurality of receivers, information corresponding to a plurality of reflections generated by the custom waveform impinging upon an object traveling through an airspace, and determining, at the controller, a position of the object, wherein the determining includes using multilateration based on the information received from the plurality of receivers. Optionally, the one or more broadcast signals correspond to digital television (DTV) signals. Optionally, he transmitting circuitry is included at a DTV broadcast tower. Optionally, the three or more subchannels are included in a 6MHz channel associated with the one or more broadcast signals. Optionally, the one or more operations further comprise, receiving information from one or more operational broadcast systems, and in response to receiving the information, adjusting the determining of the position of the object based on the information.

What is claimed is:

1. A method comprising:
transmitting, from a controller, a custom waveform to transmitting circuitry configured to embed the custom waveform into one or more broadcast signals on three or more subchannels;
receiving, at the controller and from a plurality of receivers, information corresponding to a plurality of reflections generated by the custom waveform impinging upon an object traveling through an airspace; and
determining, at the controller, a position of the object, wherein the determining includes using multilateration based on the information received from the plurality of receivers.

2. The method of claim 1, wherein the one or more broadcast signals correspond to digital television (DTV) signals.

3. The method of claim 1, wherein the transmitting circuitry is included at a DTV broadcast tower.

4. The method of claim 1, wherein the three or more subchannels are included in a 6MHz channel associated with the one or more broadcast signals.

5. The method of claim 1, further comprising:
receiving information from one or more operational broadcast systems; and
in response to receiving the information, adjusting the determining of the position of the object based on the information.

6. A system for detecting and tracking one or more airborne objects, the system comprising:
one or more bistatic or multi-static receivers;
a memory; and
one or more processors, wherein each processor of the one or more processors is communicatively coupled to each bistatic or multi-static receiver of one or more bistatic or multi-static receivers;
wherein the memory stores one or more programs that when executed by the one or more processors, cause the one or more processors to perform one or more operations comprising:
transmitting, from a controller, a custom waveform to transmitting circuitry configured to embed the custom waveform into one or more broadcast signals on three or more subchannels;
receiving, at the controller and from a plurality of receivers, information corresponding to a plurality of reflections generated by the custom waveform impinging upon an object traveling through an airspace; and
determining, at the controller, a position of the object, wherein the determining includes using multilateration based on the information received from the plurality of receivers.

7. The system of claim 6, wherein the one or more broadcast signals correspond to digital television (DTV) signals.

8. The system of claim 6, wherein the transmitting circuitry is included at a DTV broadcast tower.

9. The system of claim 6, wherein the three or more subchannels are included in a 6MHz channel associated with the one or more broadcast signals.

10. The system of claim 6, wherein the one or more operations further comprise:
receiving information from one or more operational broadcast systems; and
in response to receiving the information, adjusting the determining of the position of the object based on the information.

11. A non-transitory computer readable storage medium storing one or more programs for detecting and tracking one or more airborne objects, for execution by one or more processors of an electronic device that when executed by the electronic device, cause the electronic device to perform one or more operations comprising:
transmitting, from a controller, a custom waveform to transmitting circuitry configured to embed the custom waveform into one or more broadcast signals on three or more subchannels;
receiving, at the controller and from a plurality of receivers, information corresponding to a plurality of reflections generated by the custom waveform impinging upon an object traveling through an airspace; and
determining, at the controller, a position of the object, wherein the determining includes using multilateration based on the information received from the plurality of receivers.

12. The non-transitory computer readable storage medium of claim 11, wherein the one or more broadcast signals correspond to digital television (DTV) signals.

13. The non-transitory computer readable storage medium of claim 11, wherein the transmitting circuitry is included at a DTV broadcast tower.

14. The non-transitory computer readable storage medium of claim 11, wherein the three or more subchannels are included in a 6MHz channel associated with the one or more broadcast signals.

15. The non-transitory computer readable storage medium of claim 11, wherein the one or more operations further comprise:
receiving information from one or more operational broadcast systems; and
in response to receiving the information, adjusting the determining of the position of the object based on the information.
